(19) United States
(12) Patent Application Publication
(10) Pub. No.: US 2015/0134371 A1
(43) Pub. Date: May 14, 2015

(54) SYSTEMS AND METHODS FOR AUTOMATIC SCRAPBOOK GENERATION

(71) Applicant: StubHub, Inc., San Francisco, CA (US)

(72) Inventors: Sudhir Kishan Shivakumar, Fremont, CA (US); Szuchi Wang, San Francisco, CA (US); Qing Guo, San Francisco, CA (US); Jayanth Vasudevan, Fremont, CA (US)

(21) Appl. No.: 14/077,541

(22) Filed: Nov. 12, 2013

(51) Int. Cl. G06Q 10/02; G06Q 50/00; G06F 17/30

(52) U.S. Cl. CPC G06Q 10/02; G06F 17/30867; G06Q 50/01
USPC 705/5

(57) ABSTRACT

Computing systems and methods for facilitating automatic generation and maintenance of an online scrapbook are provided. The online scrapbook may be a repository of ticketed-event information and associated photos, comments or other mementos associated with the ticketed events. The scrapbook may include a timeline of future and past purchased-ticket events and associated links for inviting others to future events, reselling tickets to future events, sharing events with others through social networking, displaying photos of past events, or commenting on past or future events. Events for the webpage may be identified through a user account on a ticket server or by scraping a user's email account for event-related emails. The photos may be gathered from social networking sites associated with the user and sorted by event based on the time, location, or content of the photo.

### BACKGROUND

1. Technical Field

The present disclosure relates generally to electronic commerce, and more particularly, to the automatic generation and maintenance of online scrapbooks.

2. Related Art

Event attendees such as concertgoers, sports fans, opera aficionados, etc., often collect digital memorabilia from the event such as pictures taken at an attended event. Some attendees then post digital copies of those pictures on personal webpages or social networking webpages, share the pictures with friends via text messages or emails, or discuss an event on the social networking pages or other web-based chat sites.

In some situations, it may be desirable to an event attendee to have a central location at which event-related memorabilia such as pictures and comments can be stored, viewed, and, if desired, shared with friends.

However, it can be inconvenient and time consuming for an event attendee to have to collect event-related memorabilia from various locations and to maintain and update an additional website for storing and presenting that memorabilia.

It would therefore be desirable to be able to provide systems and methods for automatic electronic scrapbooking for event attendees.

### BRIEF DESCRIPTION OF THE DRAWINGS

FIG. 1 is a block diagram of an illustrative computing system that is adapted for implementing the selection and purchase of tickets for ticketed events according to an embodiment.

FIG. 2 is a block diagram of an illustrative computer system suitable for implementing on one or more devices of the computing system in FIG. 1 according to an embodiment.

FIG. 3 is a diagram of an illustrative automatically generated and maintained scrapbook webpage for a user showing how the webpage may include event-related photos and other event information according to an embodiment.

FIG. 4 is a block diagram of an illustrative system for automatically generating and maintaining event-related scrapbook pages for event attendees according to an embodiment.

FIG. 5 is an illustrative list of user emails that may be scraped for event-related information according to an embodiment.

FIG. 6 is an illustrative user social networking account having event-related photos and other event-related information according to an embodiment.

FIG. 7 is an illustrative event timeline of a user scrapbook webpage according to an embodiment.

FIG. 8 is an illustrative portion of a scrapbook having a future event with a sell link according to an embodiment.

FIG. 9 is an illustrative portion of a scrapbook having a future event with an invite link according to an embodiment.

FIG. 10 is an illustrative portion of a scrapbook having a future event with a share link according to an embodiment.

FIG. 11 is an illustrative portion of a scrapbook having a past event with event photos according to an embodiment.

FIG. 12 is an illustrative portion of a scrapbook having a past event with event comments according to an embodiment.

FIG. 13 is an illustrative portion of a scrapbook having a scrapbooking game according to an embodiment.

FIG. 14 is a flowchart showing an illustrative process that may be performed by a ticket provider for automatically generating and maintaining an online scrapbook webpage for a user according to an embodiment.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing activities related to the online purchase of tickets to ticketed events and to the automatic generation and maintenance of user scrapbook webpages associated with the ticketed events. In various particular embodiments, the devices, systems or methods can involve one or more devices in communication over a network. Such devices, systems, and methods can facilitate the selection and purchase of tickets to various ticketed events and/or the automatic generation and maintenance of user scrapbook webpages associated with ticketed events.

While the various examples disclosed herein focus on particular aspects regarding automatically providing an online user scrapbook webpage, it will be understood that the various inventive principles and embodiments disclosed herein can be applied to other types of ticketed-event applications and arrangements as well. For example, a ticket purchase that is performed in person or on a closed or proprietary computing system may utilize one or more of the aspects and features found in the various systems and methods provided.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product can comprise a non-transitory machine readable medium. The non-transitory machine readable medium can have computer readable and executable code for instructing one or more processors to perform any of the methods disclosed herein.

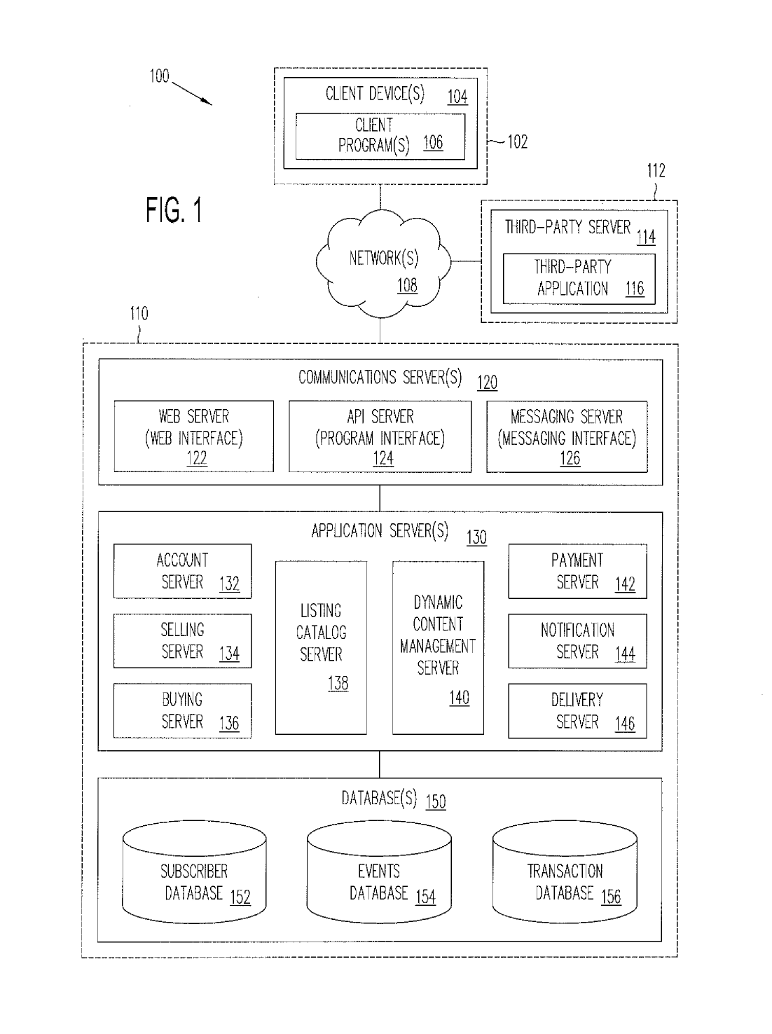

Beginning with FIG. 1, an exemplary embodiment of a computing system adapted for implementing the selection and purchase of tickets for ticketed events and/or, if desired, the automatic generation and maintenance of user scrapbook webpages associated with ticketed events is illustrated in block diagram format. As shown, a computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 (e.g., a communications session for selection and/or purchase of tickets for a ticketed event or a communications session for generating a user scrapbook webpage associated with one or more ticketed events) may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide client 102 with additional services and/or information, such as additional ticket inventory. In one embodiment, third party server 112 may be a social networking server that hosts a user's social network account. In another embodiment, third party server 112 may be an email server that hosts a user's email account. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services and/or other ticket related services such as ticketed-event scrapbooking services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, TM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, scrapbooking services, and notification services. Application servers 130 may include an account server 132, a selling server 134, a buying server 136, a listing catalog server 138, a dynamic content management server 140, a payment server 142, a notification server 144, and/or a delivery server 146 structured and arranged to provide such online marketplace, ticket fulfillment and/or scrapbooking services. One or more of application servers 130 may be configured to gather event-related information such as event dates, event times, event locations, event-related photos, and event-related comments and generate a scrapbook webpage using the gathered event-related information.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

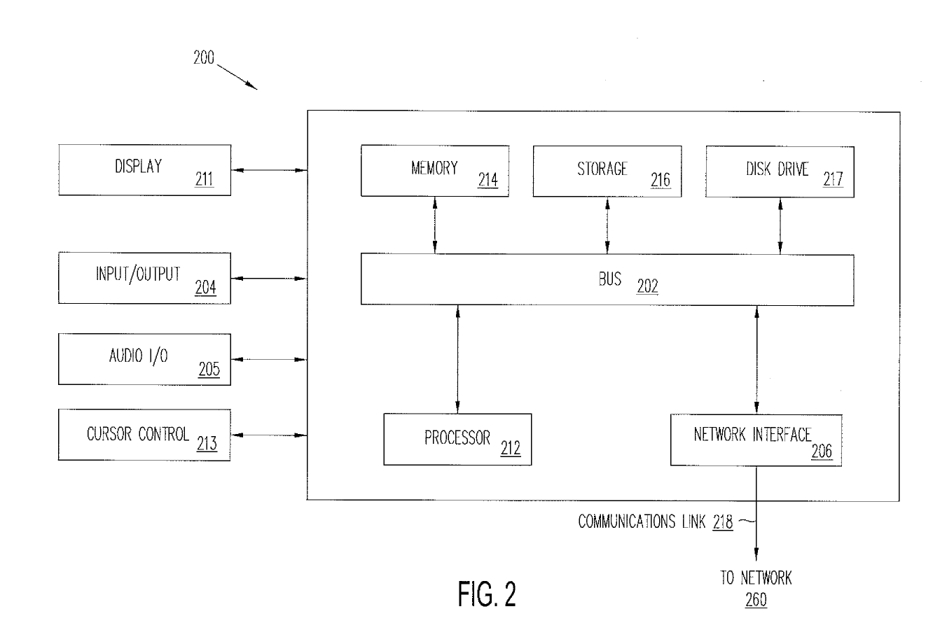

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, automatic scrapbook providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, a venue server, a third-party server or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory machine-readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof can be used to implement an automated user scrapbook webpage generation and/or maintenance operation such as the generation of a scrapbook webpage for a user that has purchased tickets for one or more ticketed events. A user scrapbook webpage may be an event-specific webpage, a venue-specific webpage, a date-range specific webpage, or an event-category-specific webpage (as examples). A user scrapbook webpage may include ticket information, event details, event-related photos, event-related text, or other information associated with one more ticketed events for which the user has purchased tickets.

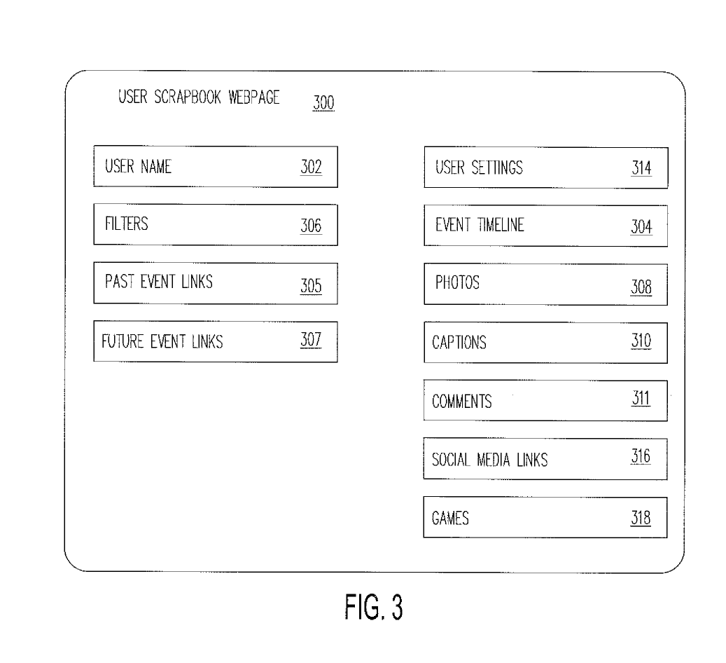

FIG. 3 is a diagram of an example of a user scrapbook website (webpage) that can be automatically generated and/or maintained using for example, a system such as system 100 of FIG. 1, by, for example, a ticket seller. As shown in FIG. 3, a scrapbook website such as a user scrapbook webpage 300 may include user information such as a user name 302 and/or user preferences 314, event-related information such as an event timeline 304, photos 308, captions 310, comments 311, and/or event links such as past event links 305 and/or future event links 307, event-related gaming information or links such as games 318, and website control features such as filters 306.

An event can be a concert, a sporting event, a theater event, a user-generated event, or any other type of event for which tickets are sold. Events can be past events that were attended by a user of website 300 or future events for which a user of website 300 has purchased tickets. Website 300 may be generated and maintained by, for example, a ticket server from which the user has purchased one or more tickets to one or more ticketed events.

Webpage 300 may include an event timeline 304. The event timeline may be a list of events for which the user has purchased tickets. The events may be displayed in a chronological order. The events may include past events and future events. Each event in the event timeline list may include event ticket information (e.g., an event date, an event time, an event venue, an event city, an event state, an event country, an artist, a category, or a team), and additional information associated with each event. The additional information for future events may be the same or different from the additional information for past events. The additional information for each event may include links, photos, comments, suggestions, or other information associated with that event.

Filters 306 may include user-selectable filters for determining which type of content is displayed on webpage 300. For example, filters 306 may include a future event filter that, when selected, causes webpage 300 to display only future events for which tickets have been purchased, a past event filter that, when selected, causes webpage 300 to display only past events that were attended by the user, a category filter (e.g., a sporting event filter, a concert filter, a theater filter, or a sport-specific filter such a baseball filter, a basketball filter, or a football filter) that, when selected, causes webpage 300 to display only events in particular categories, a time-frame filter (e.g., a year-specific filter, a month-specific filter, a season-specific filter such as a “Summers” filter or a “Summer 2013” filter) that, when selected, causes webpage 300 to display only events that occurred in the selected time frame, a location filter that, when selected, causes webpage 300 to display only events that occurred in a particular geographical location (e.g., a state, a country, a city, a town, a venue, or a portion of a venue such as a front row or a general admission section).

For example, if a user selects a time-frame filter such as a “Summer 2013” filter, webpage 300 may be updated to show only purchased-ticket events that occurred during the summer of 2013. In another example, if a user selects an event category filter such as a “baseball games” filter, timeline 304 may be updated to show only baseball-related events such as baseball games, Hall of Fame induction ceremonies, etc.

User settings 314 can be user-account settings such as webpage-update frequency settings, privacy settings, ticket-buyer account settings, ticket-seller account settings, or other settings associated with the user.

Timeline 304 may be generated, for example, by scraping a user's email to identify events for which the user purchased tickets (e.g., from the ticket seller that is generating webpage 300 or other ticket sellers), gathering additional event-related data for identified events, sorting the identified events and additional event-related data, and providing the sorted data on webpage 300.

Past event links 305 may be any suitable links that are associated with events that have already occurred at the time website 300 is viewed or updated. As examples, past event links 305 may be links to photos of past events, links to artist or team media from past events, links to attendee comments about past events, or links for sharing past events with others (e.g., through an email, through a text message, through a social media network, etc.).

Future event links 724 may be any suitable links that are associated with events that have not yet occurred such as future events for which the user has purchased tickets. As examples, future event links 724 may include a sell link for selling purchased tickets, a share link for sharing future events with others, an invitation link for inviting others to an event for which the user has purchased tickets (e.g., through an email, through a text message, through a social media network, etc.), and/or vendor links (e.g., links to hotels, taxis, restaurants, airlines, or other vendor companies that provide services and/or products related to the event to be attended).

Photos 308 can be photos taken at an event such as a past event that was attended by the user. Photos 308 can be photos taken by the user, by the user's friends, or by others who attended the event. Photos 308 may be posted to webpage 300 by the user, or (as described in further detail below) photos 308 may be automatically gathered by a server associated with webpage 300 (e.g., a ticket server) from various sources associated with the user and/or the user's online social network and placed on webpage 300. Captions 310 can be captions associated with photos 308 or other media on webpage 300. Captions 310 can be posted to webpage 300 by the user, or may be automatically gathered and placed on webpage 300 along with photos 308.

Comments 311 can be event-related comments, photo-related comments, artist-related comments, venue-related comments, or any other chat information posted to website 300 by the user, by the user's friends, by other event attendees, by community members or anyone else who desires to comment on the user's scrapbook webpage.

Social medial links 316 may be links to the user's social network webpages or applications. Social media links 316 may be links associated with past event links 305 and/or future event links 307 or may be additional social media links for sharing or gathering information related to ticketed events, user friends, or other social media information.

Games 318 may include statistical or other games in which users compete for numbers of events, event-related data posts, comments, views, photos or other scrapbook-related mementos. For example, games 318 may include a leaderboard type of display that shows a list of users that is ordered by the number of events, photos, comments, or other mementos on each user's scrapbook webpage.

Some or all of user name 302, filters 306, links 305 and 307, photos 308, captions 310, comments 311, links 316, and/or games 318 may, if desired, be presented as part of an event timeline 304.

Event data and event-related mementos such as some or all of photos 308, captions 310, comments 311, may be automatically harvested from a user's account associated with webpage 300 (e.g., a user's account with a ticket seller that hosts webpage 300) and/or from other portions of the user's online presence such as one or more email accounts and/or social networking sites associated with the user (e.g., a Facebook® webpage, a Twitter® webpage, an Instagram® webpage, a Pinterest® webpage, and/or a Google+® webpage).

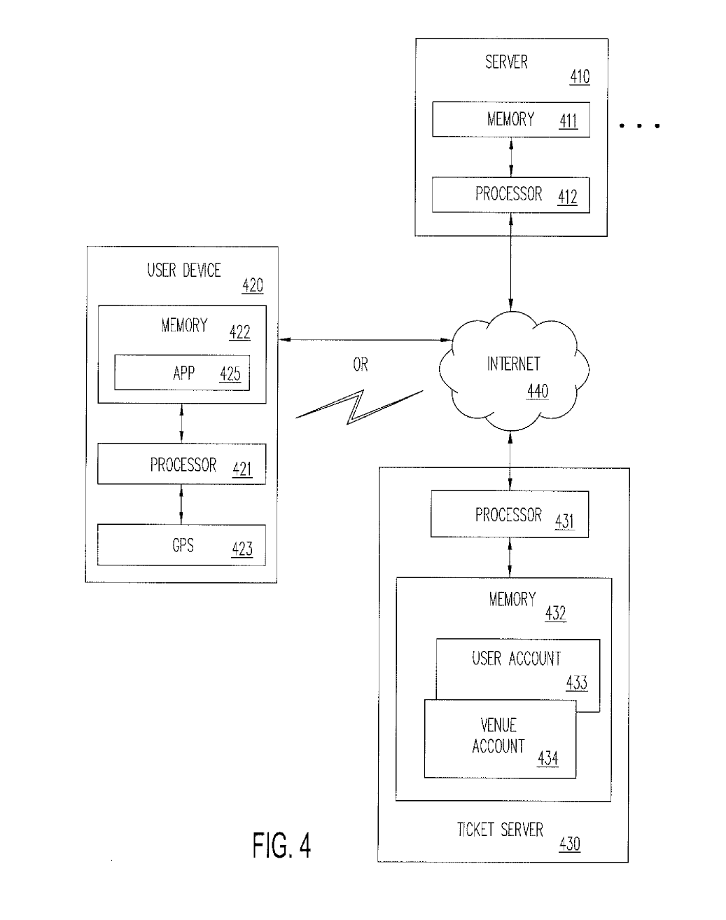

For example, as described in further detail below in connection with, for example, FIGS. 4, 5, and 6, a server such as a server associated with a ticket seller (e.g., a ticket server) may obtain permission from a user to scrape the user's emails for ticketed-event information, extract the ticketed-event information from the user's emails, obtain permission from the user to access social media accounts for event-related mementos such as event photos, event comments or other event-related media, extract the event-related mementos from the user's social media accounts, sort the extracted event-related mementos and the extracted ticketed-event information (e.g., based on time information and/or location information associated with the event-related mementos and the extracted ticketed-event information), and post the sorted event-related mementoes and associated ticketed-event information to the user's scrapbook webpage.

FIG. 4 is a block diagram showing an automatic online scrapbooking system, according to an embodiment. As shown in FIG. 4, a user device such as user device 420 may be in communication with one or more servers such as ticket server 430 and one or more additional servers 410. Servers 410 may include, for example, a social media server that hosts one or more social networking accounts for a user of user device 420 and an email server that hosts email services for the user. A user may use user device 420 to post photos, comments, or other data to a social networking site that is hosted by one of servers 410. The user may also use user device 420 to send, store, and receive emails or other electronic communications on an email account that is hosted by one of servers 410. The user may also use user device 420 to access ticket server 430 to select and purchase tickets for ticketed events from ticket server 430, to sell tickets for ticketed events, and/or to view and/or update a user scrapbook webpage that is hosted by ticket server 430.

Ticket server 430 can obtain event-related information associated with particular users from servers 410 (e.g., by scraping emails in an email account that is hosted by a server 410, crawling webpages or otherwise accessing data in accounts hosted by server 410). Ticket server 430 may, for example, be an implementation of system 110 of FIG. 1.

Server 410 can be a computer, a server, a computing tablet, or a mobile device, as examples. Server 410 can have processing circuitry such as processor 412 and storage such as memory 411.

A processor 412 on a server 410 can execute a software program stored in memory 411 for publishing user photos, comments, captions, or other data such that are posted by the user. A processor 412 on another server 410 can store and route emails or other communications for the user.

In one embodiment, servers 410 can be omitted if ticket server 430 has the information needed generate and maintain the scrapbook webpage. For example, ticket server 430 may have a database of purchased tickets and information about the tickets, venues, and events to enable ticket server 430 to provide the necessary information generating and maintaining user scrapbook webpages.

A user (e.g., a ticket purchaser that attends ticketed events, generates event-related data at an attended event, and/or resells tickets to ticketed events) can use a device such as a user device 420 to shop online for available tickets for one or more events, to post tickets on a ticket server for resale of the tickets, and/or to access a scrapbook webpage that is automatically generated online for the user. User device 420 can be a mobile device such as a cellular telephone, a tablet computer, a laptop computer, or another portable computing device. User device 420 can be a non-mobile device such as a home (land line) telephone, a desktop computer, an interactive set top box, or the like. User device 420 can be any device or combination of devices that facilitate online ticket purchasing, emailing, and/or online posting of event-related information. User device 420 may, for example, be an implementation of client device 104 of FIG. 1.

User device 420 can have a processor 421, a memory 422, a global positioning system (GPS) 423 and/or other suitable device components. Processor 421 can execute an application such as an app 425 that facilitates ticket selection and purchase operations and/or online scrapbook viewing operations. App 425 can be stored in memory 422. App 425 can provide a graphical user interface (GUI) for the user when the user is selecting and purchasing tickets online, selling tickets online, and/or viewing a scrapbook webpage online. If desired, app 425 can be a dedicated ticket purchasing app. However, this is merely illustrative. In some configurations, app 425 can be part of another app, such as a Paypal, Inc. payment provider app.

User device 420 can communicate with servers 410 and/or ticket server 430 via a network. For example, user device 420 can communicate with server 410 and/or ticket server 430 via the Internet 440. User device 420 can communicate with the Internet via either a wired connection or a wireless connection.

Ticket server 430 may be operated by an online ticket seller such as StubHub, Inc. Ticket server 430 can facilitate online ticket sales. Ticket server 430 may include processing circuitry such as a processor 431 in communication with storage such as a memory 432. Processor 431 can include one or more processors. Processor 431 can access accounts such as a user account 433 and/or a venue account 434 that are stored in memory 332. User account 433 can include information regarding the user (e.g., identification information, preferences, account numbers, purchase history, social network contacts, email contacts, email account permissions, social media account permissions, event-related mementos, purchased ticket event information, attended event information, etc.). Venue account 434 can include information regarding the venue at which past or future events occur (e.g., information regarding events, seating, and other venue features). Memory 432 can be separate from the ticker server and can be used to store any number of user accounts 433 and venue accounts 434. Memory 432 can be distributed, e.g., have portions thereof disposed at a plurality of different locations. Other accounts may also be accessible by processor 431, such as accounts of users selling tickets that include ticket details, such as price, quantity, location, and event information, and financial information that enables funds to be deposited into seller accounts when their tickets are sold.

Ticket server 430 may include one or more servers located at one or more locations. Thus, the ticket server 430 can be geographically and operationally distributed if desired. Ticket server 430 can be part of another system, such as a payment provider system. Servers 410 can communicate with ticket server 430 over a wired or wireless connection such as via a network. For example, a server 410 can communicate with ticket server 430 via Internet 440. Servers 410 can communicate with a plurality of different ticket servers 430. Ticket server 430 can communicate with a plurality of different servers 410. A plurality of different ticket servers 430 can communicate among themselves and can be considered herein as being the same as a single ticket server 430. The user can operate user device 420 to interact with ticket server 430 so that the user can select and purchase tickets and/or view, update, share, or otherwise interact with an user scrapbook associated with purchased tickets online.

Servers 410, user device 420, other mobile devices, and server 430 can communicate with one another via a network, such as the Internet 440 or via one or more other networks, such as local area networks (LANs), wide area networks (WANs), cellular telephone networks, and the like. Servers 410, user device 420, other mobile devices, and server 430, and other devices (e.g., a social network device) can communicate with one another, at least partially, via one or more near field communications (NFC) methods or other short range communications methods, such as infrared (IR), Bluetooth, WiFi, and WiMax.

When a user wishes to shop for tickets online, the user can open a ticket seller webpage or can access the ticket seller using an application such as app 425. When a user wishes to view their user scrapbook webpage or a scrapbook webpage of another user, the user can open a scrapbook webpage or can access the scrapbook webpage using an application such as app 425. The user can open the user scrapbook webpage using user device 420, for example. The user scrapbook webpage can be hosted on ticket server 430, or on any other server or device.

Website 300 may be implemented using web interface 122 of FIG. 1, may be provided to user device 420 by ticket server 430, or may be otherwise provided to or accessed by a user.

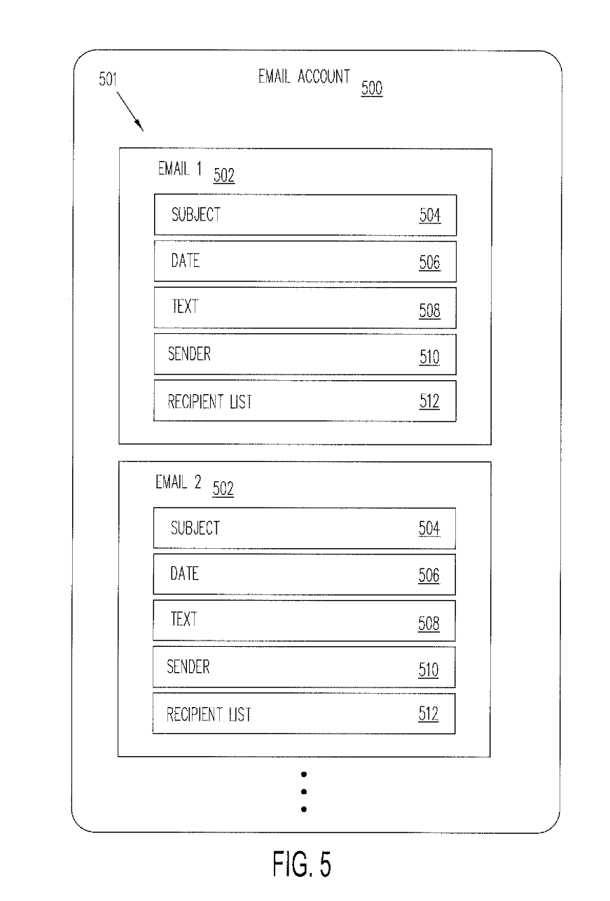

In order to gather event information for events for which a user has purchased tickets, computing equipment such as processor 431 of server 430 may access a user's email account such as email account 500 of FIG. 5. As shown in FIG. 5, a user's email account may include a list 501 of emails 502. Each email 502 may be a received email or a sent email. Each email 502 may include various email data such as a subject 504, a send date 506, text 508, one or more senders such as sender 510, a recipient list 512 (e.g., a carbon-copy (cc) list, a blind-carbon-copy (bcc) list, or other list of recipients of the email), or other data such as attached or embedded files.

In some situations an email 502 may be a confirmation email from a ticket seller notifying the email account holder that tickets for a ticketed event have been successfully purchased. Some emails, such as this type of confirmation email, can include ticket information such as the ticket price, the event date, the event artist or team (as examples), the seat section, the seat row, the seat number, the number of tickets, or other event information. This type of ticket information, along with any other information such as event information included in emails 502 can be gathered by a scrapbook server such as ticket server 330 in an email scraping operation.

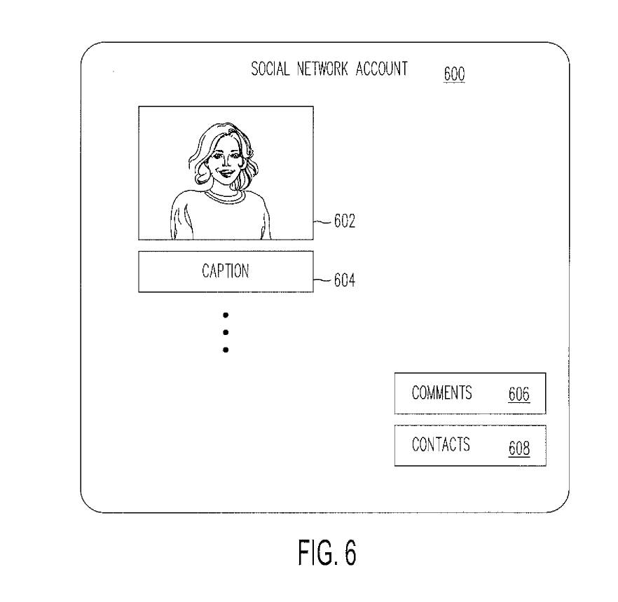

In order to gather additional event-related data such as event mementos for events for which a user has purchased tickets, computing equipment such as computing equipment of server 430 may access one or more social network accounts such as social network account 600 of FIG. 6. Social network account 600 may be a user's social network account or may be a social network account of one of the user's email contacts as determined by scraping email account 500 of FIG. 5.

As shown in FIG. 6, a social network account may include posted data such as one or more photos such as photo 602, one or more photo captions such as caption 604, one or more comments such as comments 606 (e.g., user comments or user friend comments), and one or more social network contacts such as contacts 608.

Photo 602, caption 604, and comments 606 may be posted to account 600 by the owner of account 600 or by others. A processor such as a processor associated with a scrapbooking server (e.g., a ticket server with scrapbooking capabilities) may obtain social networking data such as photo 602, caption 604, and comments 606, determine whether any or all the social networking data correspond to one of the ticketed events identified from email account 500, and post corresponding ones of photo 602, caption 604, comments 606 to the users scrapbook webpage.

For example, a photo such as photo 602 may have a time stamp corresponding to a time during a particular event for which the user purchased a ticket, thereby indicating that the photo was taken at that event. As other examples, photo 602 may have been posted to account 600 during the event, may have a caption that refers to the event, may have a geographical tag associated with an event venue, or may have image content that identifies the event (e.g., a venue sign, an identifiable venue feature or artist feature, etc.). If desired, a scrapbook server may crawl public webpages (e.g., social network webpages) of contacts identified in contacts 608 or in email contacts associated with email account 500 to obtain additional event mementos.

Photo 602 may be posted to website 300 to form one of photos 308. Caption 604 may be posted to website 300 to form one of captions 310. Comments 606 may be posted to website 300 to form one of comments 311.

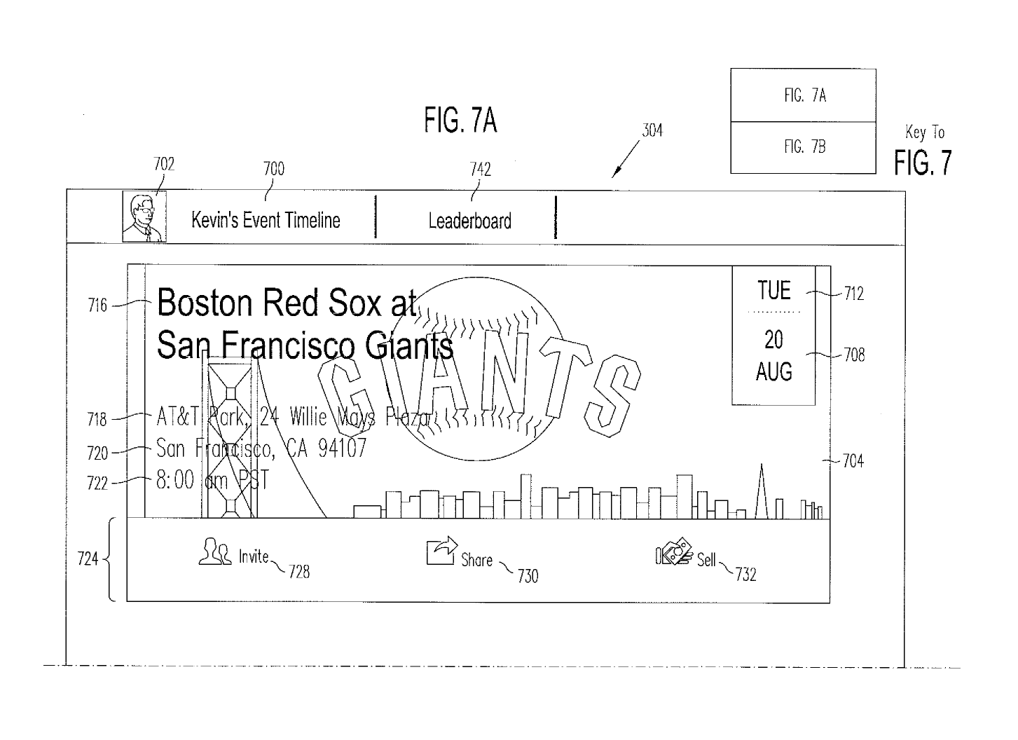

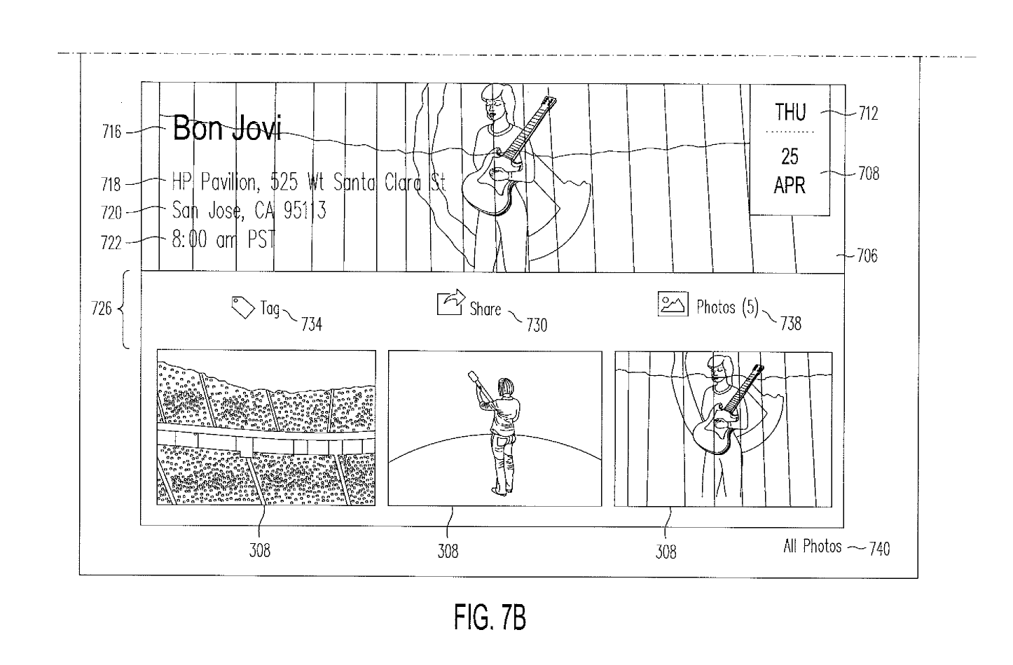

FIGS. 7, 8, 9, 10, 11, 12, and 13 show portions of an exemplary user scrapbook webpage such as webpage 300 according to various embodiments.

FIG. 7 illustrates an event timeline 304 that may be included on website 300. As shown in FIG. 7, event timeline 304 may include a header such as a user-associated header 700 and a user icon such as an icon 702. Header 700 may include the user's name or a nickname or username for the user (e.g., “Kevin's Event Timeline” for a user named Kevin). Icon 702 may be a photo of the user, another photo, an animation, or other icon chosen by or automatically assigned by the user.

Event timeline 304 may include event indicators such as future event indicator 704 for an event that has yet to occur and past event indicator 706 for an event that has already occurred. If desired, timeline 304 may include current event indicators (not shown) for events that are currently in progress at a given time.

Future event indicator 704 and past event indicator 706 may each include event identifying information such as an attraction identifier 716 (e.g., an artist name such as “Bon Jovi”, sports game opponents such as “Boston Red Sox at San Francisco Giants”, or other artist, team, or attraction name), location information such as a venue identifier 718 (e.g., “AT&T Park, 24 Willie Mays Plaza” or “HP Pavilion, 525 W. Santa Clara St.”), a geographical location identifier 720 (e.g., “San Francisco, Calif. 94107” or “San Jose, Calif. 95113”), event-time information 722 (e.g., “8:00 am PST”), event-date information 708 (e.g., “August 20” or “April 25”), weekday information 712 (e.g., “TUE” or “THU”) or other information that identifies an event such as team logos, artist-related logos, or other event information.

Event information may be gathered from user accounts, from event data stored by a ticket server, from venues, artists, or other third parties.

Event indicators such as future event indicator 704 and past event indicator 706 may have associated links, mementos, or other information that can be selectively displayed within event timeline 304. Links and mementos associated with future event indicators 704 may be the same as, or different from, links and mementos associated with past even indicators 706.

In the example of FIG. 6, future event indicator 704 includes future event links 724 that include an invite link 728, a share link 730, and a sell link 732. Past event indicator 706 includes past event links 726 that include a tag link 734, a share link 730, and a photos link 738. Indicators 704 and 706 may include other links such as a comments link, a games links, a vendor link, or other suitable clickable or otherwise selectable links to information relevant to an indicated event.

Invite link 728 may provide a user with options for inviting others to the associated event of the event indicator 704. Share link 730 may provide a user with options for posting information about the associated event to other online locations such as social network webpages or applications. Sell link 732 may provide a user with options for selling previously purchased tickets for a future event (e.g., through the ticket seller website that is hosting scrapbook webpage 300 by which timeline 304 is displayed).

Photos link 738 may provide a user with options for displaying photos taken at the associated event of the event indicator 706 (e.g., an event that was attended by the user). Photos link 738 may include an indication of the number of available photos for viewing. A viewer of timeline 304 may click, mouse over, or otherwise select photos link 738 in order to display photos such as event photos 308 in a location in timeline 304 that is associated with the past event indicator 706 for the event at which the photos were taken. Tag link 734 may provide a user with options for tagging one or more photos 308. Timeline 304 may include an all-photos link 740 for displaying all photos associated with the event for the indicator 706.

As shown in FIG. 7, an event timeline such as event timeline 304 on a user scrapbook webpage may include a games link such as leaderboard link 742. Leaderboard link 742 may provide a user with a leaderboard display that shows a ranked list of event attendees that is ordered based on the number of photos, comments, friends, or other mementos on each user's scrapbook webpage.

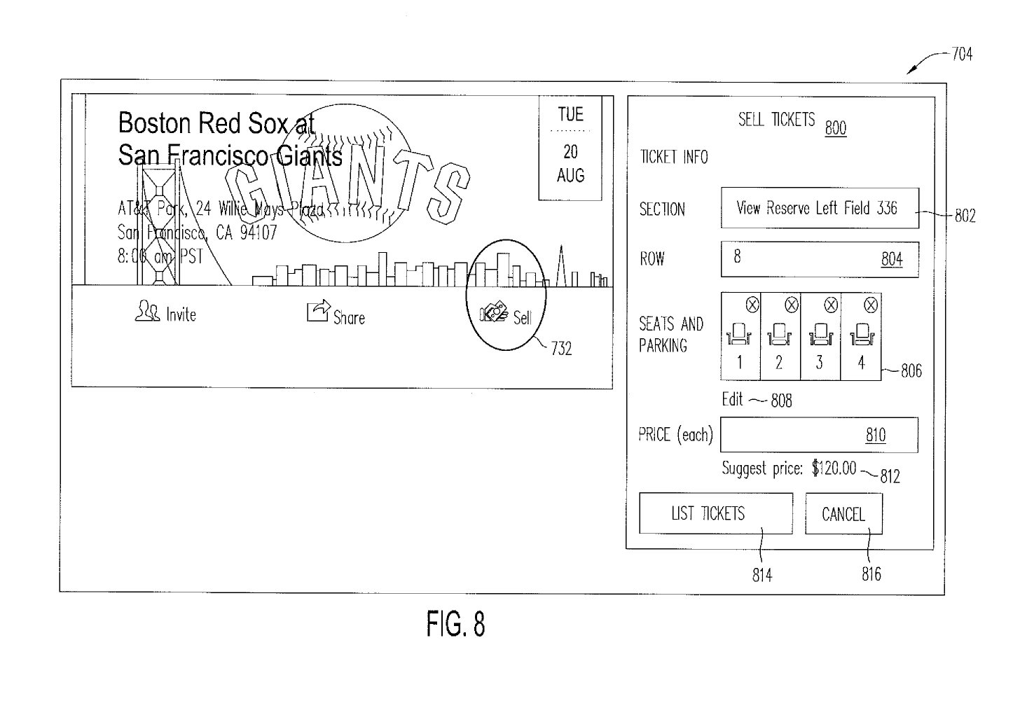

FIG. 8 shows a close-up view of future event indicator 704 showing how sell link 732 may provide a user with the ability to sell tickets for the event associated with that indicator 704. As shown in FIG. 8, when a user selects sell link 732 (e.g., by clicking, mousing over, or finger tapping the link), a window such as sell window 800 may be provided to the user. Sell window 800 may be provided as a standalone window, a pop-up window, or may be otherwise provided to the user.

Sell window 800 may include input fields for ticket information associated with the tickets that the user has purchased for the event associated with indicator 704. The input fields may include a section field 802, a row field 804, a seats and parking field 806, and a price field 810. A user that desires to sell previously purchased tickets may enter ticket information into the input fields. In the example of FIG. 8, section field 802 has been populated with section information “View Reserve Left Field 336”, row field 804 has been populated with row information “8”, and seats and parking field 806 has been populated with seat information “1”, “2”, “3”, and “4”. It will be appreciated that these examples are merely illustrative and that fields 802, 804, and 806 can be populated with any suitable ticket sale information. Sell window 800 may include a seat-edit link 808 for editing seat information that has been previously populated.

Fields 802, 804, and 806 may be populated by the user by entering the appropriate information in the appropriate field based on the tickets the user wishes to sell. However, this is merely illustrative. If desired, fields 802, 804 and 806 can be automatically populated by webpage 300 (e.g., by the server that is hosting the webpage) using ticket information that was extracted from the user's account with the ticket seller and/or ticket information that was extracted by scraping the user's email or other accounts.

For example, if a user purchased the tickets associated with indicator 704 from the ticket seller that is hosting the scrapbook webpage, the ticket seller can populate the ticket information fields of sell window 800 using only information stored by the ticket seller. However, if the user purchased the tickets from another ticket seller, website 300 may still be able to automatically populate the fields of sell window 800 using the ticket information obtained in an email scrape. In this way, scrapbook webpage 800 may help a user resell tickets purchased from any ticket seller with minimal effort and time from the user.

If desired, price field 810 may be populated by the user with a desired selling price for the tickets or price field 810 may be automatically populated (e.g., with a face-value price, or a suggested price based on the selling price of similar tickets at a current time). As shown, sell window 800 may provide the user suggested price information 812. Suggested price information 812 may be generated by a ticket seller that is hosting webpage 300 based on other sales of tickets by the ticket seller or by other ticket sellers. For example, if tickets in the same section were recently sold for $120.00, a user may be provided with a suggested price of $120.00. Suggested price 812 may be updated at any suitable interval such as when new ticket sales information is gathered by the ticket seller or each time the user selects sell link 732.

Sell window 800 may provide the user with a “list tickets” button 814 and a “cancel” button 816 that give the user options for selling or not selling the tickets associated with indicator 704.

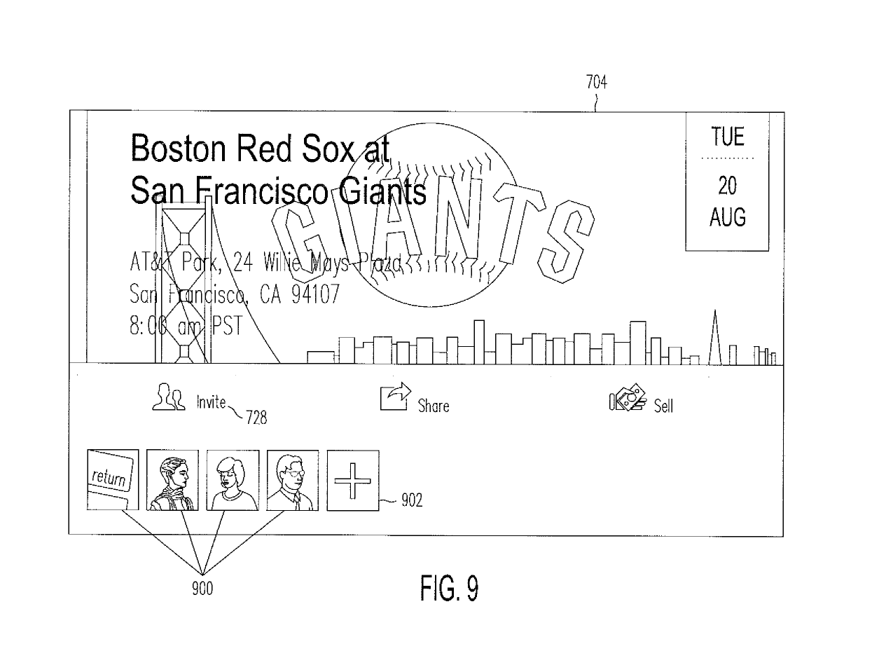

FIG. 9 shows a close-up view of future event indicator 704 showing how invite link 728 may provide a user with the ability to invite others to the event associated with that indicator 704. As shown in FIG. 9, when a user selects invite link 728 (e.g., by clicking, mousing over, or finger tapping the link), links 900 to other users (e.g., email contacts of the user, social network contacts of the user, friends of the user, or others associated with the user or others who may be interested in the event) may be provided to the user. As shown in FIG. 9, links 900 may be presented with icons associated with the other users. However, this is merely illustrative. If desired, links 900 may be presented to the user as a list or may be otherwise presented to the user.

When a user selects one of links 900, the user may be provided with options for sending an invitation to the other user associated with that link 900. Invitation options may include an email option, a social network option, a text message option or other options for contacting the person that the user wishes to invite to the event.

When invite link 728 is selected, the user may also be provided with an add link 902 for adding other users to the list of potential invitees that are presented with link 728 is selected.

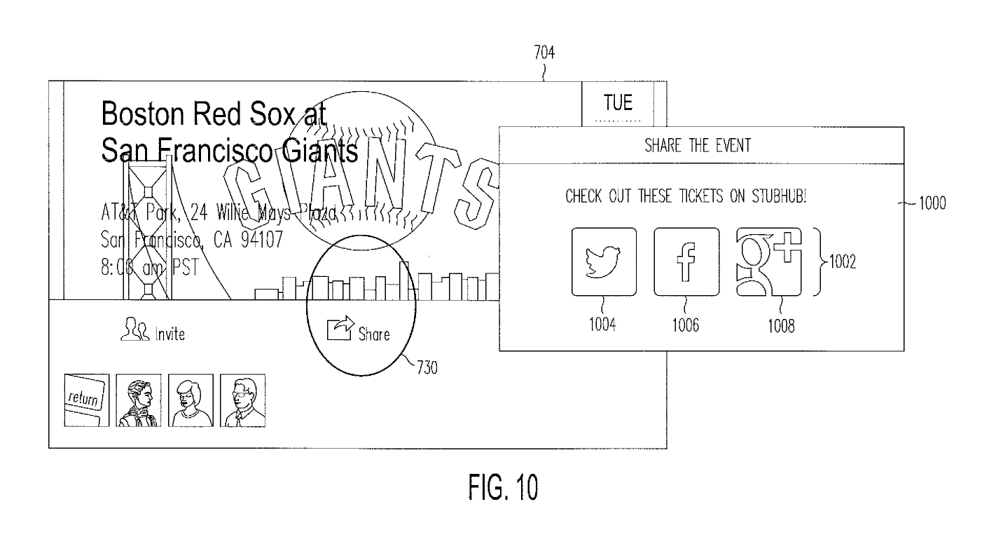

FIG. 10 shows a close-up view of future event indicator 704 showing how share link 730 may provide a user with the ability to share the event associated with that indicator 704. As shown in FIG. 10, when a user selects share link 730 (e.g., by clicking, mousing over, or finger tapping the link), a window such as share window 1000 may be provided to the user. Share window 1000 may be provided as a standalone window, a pop-up window, or may be otherwise provided to the user.

Share window 1000 may include social networking share links 1002 such as a Twitter® share link 1004, a Facebook® share link 1006, and/or a Google+® share link 1008 (as examples). Social networking share links 1002 may, when selected, add the event associated with indicator 704 to the user's social network webpage, to a comment associated with the social network, or may provide the user with other options (e.g., an email option, a text message option, etc.) for sharing the event with friends or others.

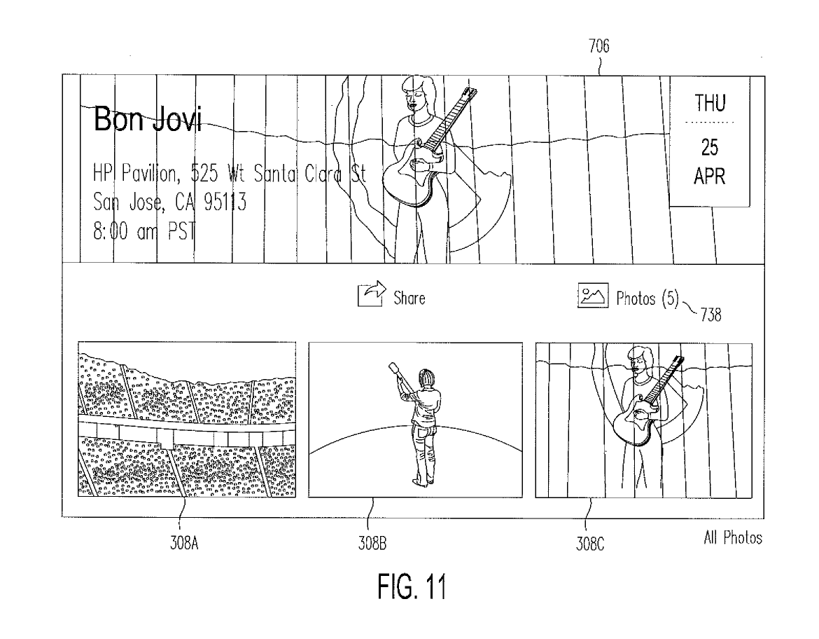

FIG. 11 shows a close-up view of past event indicator 706 showing how photos link 738 may provide a user with the ability to view photos from the event associated with that indicator 704. As shown in FIG. 11, when a user selects photos link 738 (e.g., by clicking, mousing over, or finger tapping the link), photos such as a crowd photo 308A, an artist/team photo 308B, and a stage photo 308C may be displayed under indicator 706. However, this is merely illustrative. If desired, photos such as photos 308A, 308B, and 308C, or other photos may be displayed in a new browser window, in a photo-specific webpage, or may be otherwise provided to a user that has selected photos link 738. In the example of FIG. 11 three photos taken during a “Bon Jovi” event are shown. However, this is merely illustrative. If desired, any number of event-related photos may be displayed in connection with indicator 706.

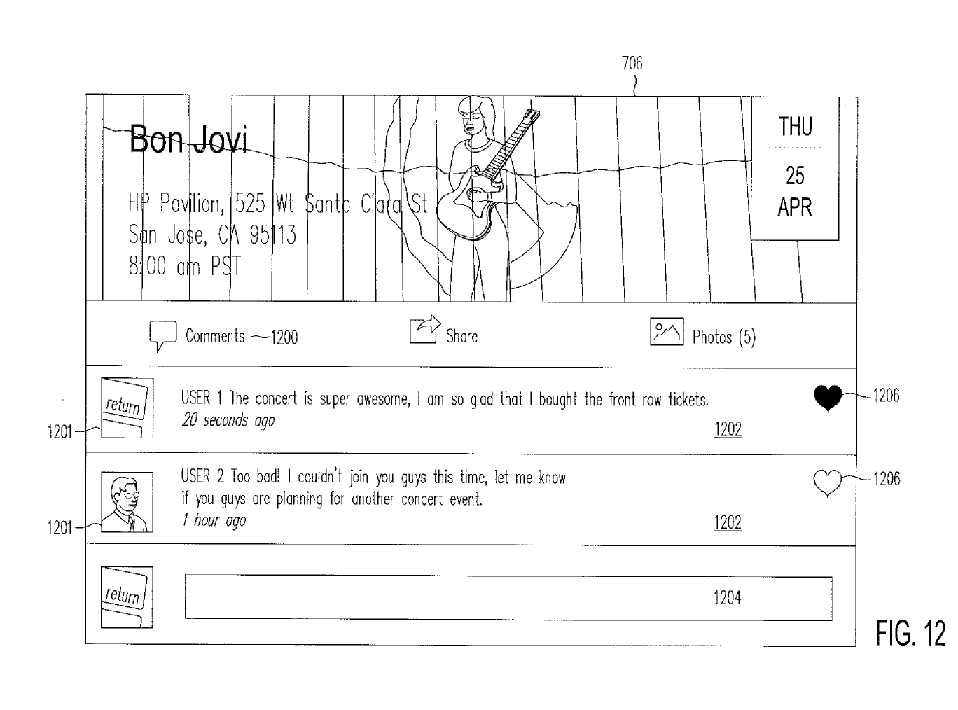

FIG. 12 shows a close-up view of past event indicator 706 showing how past event indicator 706 may include a comments link 1200. Comments link 1200 may provide the user and other users such as other viewers of the user's scrapbook webpage to enter and read comments regarding the event associated with that indicator 706. As shown in FIG. 12, when a user selects comments link 1200 (e.g., by clicking, mousing over, or finger tapping the link), comments such as comments 1202 and a comment entry field 1204 may be displayed below indicator 706. However, this is merely illustrative. If desired, comments such as comments 1202, or other comments may be displayed in a new browser window, in comments-specific webpage, or may be otherwise provided to a user that has selected comments link 1200. In the example of FIG. 12 each comment 1202 includes comment text (e.g., “The concert is super awesome, I'm so glad that I bought the front row tickets.” and “Too Bad! I couldn't join you guys this time, let me know if you guys are planning for another concert event.”). Comments such as comments 1202 may be entered during an event, after the event, or at any other time. Comments 1202 may each include a clickable icon 1206 for indicating approval of that comment. Each comment 1202 may have an icon 1201 for the user that entered that comment.

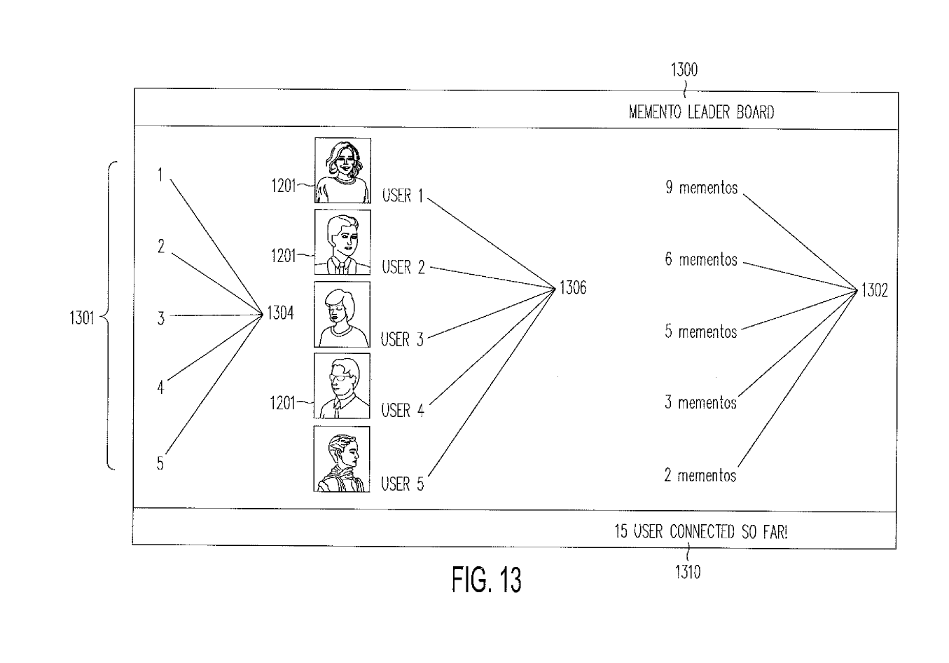

Referring again to FIG. 7, when a user selects leaderboard link 742, a networking game such as memento leaderboard 1300 of FIG. 13 may be provided to the user. Leaderboard 1300 may, for example, be an implementation of one of games 318 of FIG. 3.

As shown in FIG. 13, leaderboard 1300 may include a list 1301 of users 1306 ordered by each user's rank 1304. Ranks 1304 may correspond to the number 1302 of mementos on each user's scrapbook webpage. In this way, user's may be provided with a game in which the user's compete for the highest number of events, event photos, event comments, or other event-related mementoes. Leaderboard 1300 may also include a count display 1310 that indicates, for example, the number of other connected user's associated with the user of webpage 300. The leaderboard of FIG. 13 is merely illustrative. If desired, other statistical or other event-based competitions and/or rankings may be provided by website 300 (e.g., rankings based on the number of event attended by each user 1306 or the number of events of a particular artist or team attended by each user 1306).

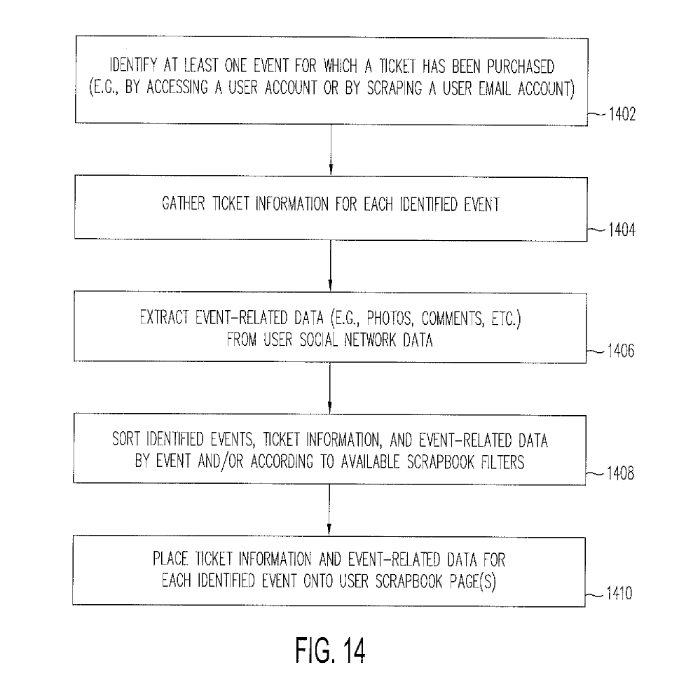

FIG. 14 is a flow chart of illustrative steps that may be used in providing a user scrapbook webpage for a particular user.

At step 1402, computing equipment such as ticket provider computing equipment (e.g., processor 431 of ticket server 430 of FIG. 4) may identify at least one event for which a ticket has been purchased by a user of the ticket server (e.g., by accessing a user account on the ticket server or by scraping a user email account as described above in connection with, for example, FIG. 5).

At step 1404, ticket information for each identified event may be gathered (e.g., from the user account or from the scrape of the user email account).

At step 1406, the computing equipment may extract event-related data (e.g., photos, comments, etc.) from user social network data associated with the user as described above in connection with, for example, FIG. 6.

At step 1408, the computing equipment may sort the identified events, the ticket information, and the event-related data by event. Sorting the identified events, the ticket information, and the event-related data may include associating the event-related data and the ticket information with appropriate ones of the identified events (e.g., by determining that a photo in the event-related data was taken during one of the identified events from the user email using the time the photo was taken and an associated event time) and storing the associated information in a memory such as memory 432 of ticket server 430. If desired, the identified events and event-related data may be further sorted and stored according to available scrapbook filters (e.g., a category filter, a venue filter, a time-frame filter, other filters as described above in connection with FIG. 3 or other filters). Sorting the identified events, the ticket information, and the event-related data may include sorting the identified events into past events and future events.

At step 1410, the ticket information and the event-related data may be placed onto one or more user scrapbook webpages such as user scrapbook webpage 300 of FIG. 3 (e.g., by storing the sorted ticket information and event-related data in a user-accessible portion of memory such as memory 432 of server 430). Placing the ticket information and the event-related data onto the user scrapbook webpage may include providing past event indicators associated with past events and future event indicators associated with future events, as described herein, on the webpage.

In general, the steps described above in connection with FIG. 14 may be performed in any suitable order and/or combined in any suitable way for providing a generating and/or maintaining a user scrapbook webpage.

In one embodiment, steps 1406 and 1408 may be performed without performing steps 1402 or 1404 (e.g., using events and event-related data associated with a user account or other accounts on a ticket server).

In various embodiments, ticketed events such as the events described above can be social or recreational events, such as concerts, musicals, shows, fairs, amusement parks, sporting events and the like. Alternatively, such events can be business related events, such as business meetings, conferences, retreats, and the like.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system for providing an automatic online scrapbook, comprising:
a non-transitory memory configured to store, in a user-accessible location, a user scrapbook webpage; and
a processor coupled to the non-transitory memory, wherein the processor is configured to automatically generate and maintain the user scrapbook webpage by gathering event-related data associated with ticketed events for which a user has purchased tickets and providing the event-related data on the user scrapbook webpage.

2. The system defined in claim 1, wherein the processor is further configured to gather the event-related data by a scraping an email account of the user and obtaining social network data of the user from a social network account.

3. The system defined in claim 2, wherein the processor is further configured to provide an event timeline on the user scrapbook webpage that includes the event-related data.

4. The system defined in claim 3, wherein the event timeline comprises a past event indicator associated with an event that has already occurred, wherein the past event indicator includes past event links.

5. The system defined in claim 4, wherein the event timeline comprises a future event indicator associated with an event that has not yet occurred, wherein the future event indicator includes future event links.

6. The system defined in claim 5, wherein the past event links include a tag link, a photos link, and a share link.

7. The system defined in claim 6, wherein the future event links include an invite link, an additional share link, and a sell link.

8. The system defined in claim 1, wherein the processor is further configured to provide at least one game on the user scrapbook webpage.

9. A method, comprising:
identifying, electronically by a processor, at least one event for which a user has purchased a ticket;
gathering, electronically by the processor, ticket information for the at least one event;
gathering, electronically by the processor, event-related data associated with the at least one event; and
providing, electronically by the processor, the ticket information and the event-related data to the user automatically on an online scrapbook webpage.

10. The method of claim 9, wherein the event-related data includes a photo that was taken at the at least one event.

11. The method of claim 10, wherein the gathering of the event-related data comprises gathering the event-related data from a social network account of the user.

12. The method of claim 11, wherein the processor comprises a processor of a ticket server and wherein the identifying comprises identifying the at least one event using a user account of the ticket server.

13. The method of claim 11, wherein the identifying comprises scraping an email account of the user.

14. The method of claim 13, wherein the gathering of the ticket information comprises obtaining the ticket information from the scraping of the email account of the user.

15. The method of claim 14, wherein the ticket information includes information selected from the group consisting of an event time, an event date, an event venue, and an event city.

16. The method of claim 9, wherein the at least one event comprises a plurality of events and wherein the method further comprises sorting the plurality of events into past events and future events.

17. The method of claim 16 wherein the providing comprises providing at least one past event indicator associated with the past events and at least one future event indicator associated with the future events.

18. A non-transitory machine-readable medium having a plurality of machine-readable instructions which, when executed by one or more processors of a server, are adapted to cause the server to perform a method comprising:
identifying at least one event for which a user has purchased a ticket;
gathering ticket information for the at least one event;
gathering event-related data associated with the at least one event; and
providing the ticket information and the event-related data to the user automatically on an online scrapbook webpage.

19. The non-transitory machine-readable medium defined in claim 18, wherein the method further comprises:
sorting the at least one event into past events and future events.

20. The non-transitory machine-readable medium defined in claim 19, wherein the method further comprises:
providing, on the online scrapbook webpage, at least one past event indicator associated with the past events and at least one future event indicator associated with the future events.
